(19) United States
(12) Patent Application Publication
(10) Pub. No.: US 2024/0278872 A1
(43) Pub. Date: Aug. 22, 2024

(54) AXIALLY DECOUPLED CRANK ARM

(71) Applicant: Justin Welsh, Sunnyvale, CA (US)

(72) Inventor: Justin Welsh, Sunnyvale, CA (US)

(21) Appl. No.: 18/648,394

(22) Filed: Apr. 28, 2024

(51) Int. Cl. B62M 3/06

(52) U.S. Cl. CPC B62M 3/06

(57) ABSTRACT

The invention discloses an Axially Decoupled Crank Arm (ADCA) that revolutionizes cycling ergonomics by redistributing torque requirements throughout the pedal stroke. This innovative crank assembly system comprises a spindle, an arm, and a tube geometry component with helical fluting, enabling partial decoupling of rotational motion. As the cyclist pedals, the arm rotation causes lateral movement of the tube geometry component, reducing torque demands at the pedal's top and bottom positions. Compression springs counter lateral movement, providing resistance and converting kinetic energy to potential energy. The ADCA offers customizable decoupling levels, compatibility with various bottom bracket configurations, and the ability to accommodate different pedal styles. Additionally, a locking mechanism allows cyclists to switch between decoupled and coupled modes for versatile riding experiences. With its transformative design, the ADCA enhances cycling performance, enabling smoother transitions and improved efficiency for riders across diverse terrains

### FIELD OF THE INVENTION

The present invention relates to the field of cycling technology. Specifically, the invention pertains to a novel crank assembly system designed to improve pedaling ergonomics and efficiency for cyclists across various terrains and riding conditions.

### BACKGROUND OF THE INVENTION

In the field of cycling, efficiency and ergonomics play pivotal roles in the overall riding experience and performance. Traditional crank arm assemblies have long been utilized in bicycles and other pedal-driven machines, providing the mechanical linkage between the rider's legs and the propulsion system. However, despite their widespread use, conventional crank arm systems have inherent limitations that can impede cycling biomechanics and hinder performance, particularly in challenging riding conditions such as steep inclines or abrupt accelerations.

US20150203171A1 discloses a pedal assembly mountable on a bicycle crank arm associated with a bicycle drive assembly; the pedal assembly comprising: a pedal which is operably connected to a retaining member; the retaining member including a first end and a second end and on one side a spigot which engages the crank arm to enable support of the pedal assembly by the crank arm; the pedal including a first connection which engages the first end of the retaining member and a second connection which engages the second end of the retaining member, wherein the first and second connections allow the pedal to move relative to the retaining arm during rotation of the crank arm.

U.S. Pat. No. 6,840,136B1 discloses a pedal drive mechanism that provides continuous, uninterrupted torque to the drive chain or belt. The continuous torque effect is a result of establishing two separate but connectively joined axes of rotation that transmit pedal crank force to the drive chain. The assembly of a right pedal crank rotative mounted about left pedal output crank are connectively fastened to the left pedal crank through the bottom bracket bearing defines the first axis of rotation. The assembly of the chain sprockets, sprocket interface and sprocket support are rotatively mounted by a sealed bearing about a bearing inner race support and eccentric flange establish a second axis of rotation. The fixtures of these two axes of rotation are connectively joined by articulating links with self-aligning sealed bearings.

U.S. Pat. No. 9,327,799B2 discloses a cycle with tapered drivetrain connections. The cycle includes a frame, a crank rotatably connected to the frame, and a driven wheel rotatably connected to the frame. The crank includes a crank arm and a crank spindle rotatably connected to the frame and non-rotatably connected to the crank arm. The crank spindle includes a crank mating surface to interface with the crank arm. The diameter of the crank spindle continuously decreases along at least a portion of the crank mating surface in a lateral direction. The crank arm includes a crank bore to interface with the crank mating surface. At least a portion of the crank bore has a diameter that continuously decreases in lateral direction. At least a portion of the crank bore taper has a taper rate and diameter equal to a taper rate and diameter of at least a portion of the crank spindle taper.

U.S. Pat. No. 8,628,102B2 discloses an extended crank system for a bicycle or similar crank driven system has frame with a bottom bracket and a pair of cranks operatively connected to opposite ends of the bottom bracket. A chain ring is operatively connected to one of the cranks. A crank hub is rotatably connected to each of the cranks and extends away from and is substantially parallel to the bottom bracket. A pair of crank extensions is connected to the crank hub, and a pair of crank extension hubs is connected to the pair of crank extensions. Additionally, a pair of crank followers is pivotably connected to opposite ends of the crank extension hubs at respective first ends of the crank followers, as well as pivotably connected to opposite ends of a top bracket mounted to the frame above the chain ring and behind the seat post, at respective second ends of the crank followers.

WO2016186584A1 discloses a crank mechanism for the bicycle drive based on the following: a-shaft with centrically fixed driving sprocket and placed in the bicycle frame. On both shaft ends, cranks are placed via freewheels, which ensure the torque transfer from the cranks to the shaft during the cranks rotation in the direction of the cyclist's force action on the pedals as well as the free rotation of the cranks in the opposite direction. Since the cranks rotation is not coupled mutually, these can be used also for mutually counter-directed swinging movement, mainly in the area next to the position where the cyclist's force acting on the pedals is perpendicular to the cranks.

One significant challenge faced by cyclists is the inconsistency in torque requirements throughout the pedal stroke. In a conventional crank arm assembly, the resistance force remains relatively constant across the entire 360-degree rotation, leading to inefficiencies, especially during the phases where the cyclist's capacity to generate torque is lower. This uniform resistance profile can result in increased fatigue, decreased power output, and less-than-its peak performance, particularly during critical moments such as starting from a standstill or climbing steep gradient.

Moreover, traditional crank arm systems often fail to adequately accommodate variations in individual cycling techniques and biomechanics. Cyclists with different riding styles, leg strengths, and preferences may find it challenging to enhance their pedaling efficiency with standard crank assemblies, leading to decreased performance and potential discomfort or injury over time. Additionally, the lack of adjustability in conventional crank arm designs limits their versatility and adaptability to diverse terrain and riding conditions, further exacerbating the challenges faced by cyclists seeking enhanced performance and comfort.

Furthermore, the reliance on fixed mechanical linkages in traditional crank arm systems constrains the ability to fine-tune torque distribution and improve pedaling dynamics for improved efficiency and comfort. This limitation becomes particularly pronounced in scenarios where cyclists encounter varying terrain profiles or require rapid changes in pedaling cadence. Without the flexibility to modulate torque requirements and adapt to dynamic riding conditions, cyclists may experience diminished performance and increased fatigue, limiting their ability to push their limits and achieve their full potential on the bike.

In light of these challenges, there is a recognized need within the cycling community for innovative solutions that address the limitations of conventional crank arm assemblies and enhance pedaling ergonomics, efficiency, and performance. By developing a crank assembly system that introduces partial decoupling of rotational motion and adjusts torque distribution throughout the pedal stroke, cyclists can potentially overcome longstanding biomechanical constraints and unlock new levels of performance and comfort.

### SUMMARY OF THE INVENTION

To address the foregoing problems, in whole or in part, and/or other problems that may have been observed by persons skilled in the art, the present disclosure provides compositions and methods as described by way of example as set forth below.

A principal object of the invention is to improve pedaling ergonomics by introducing a crank assembly system that redistributes torque requirements throughout the pedal stroke.

Another object of the invention is to enhance pedaling efficiency by optimizing torque distribution and power transfer during cycling.

Another object of the invention is to offer cyclists the flexibility to customize the degree of decoupling according to their individual preferences and riding conditions.

Another object of the invention is to ensure compatibility and adaptability with existing bicycle components and bottom bracket configurations.

In view of the foregoing, the present invention provides a crank assembly system. The system comprises a spindle having a central subsection configured to fit within a hollow bottom bracket, a ring having a cylindrical tube structure with helical fluting on both an inner surface and an outer surface thereof, wherein said ring is configured to screw onto said spindle and said ring having helical fluting on an outer surface thereof. The ring is configured to receive a compatibly fluted arm. An arm having a cylindrical tube structure with helical fluting on an inner surface thereof. The arm is configured to receive said ring in a manner allowing rotational motion therebetween. Rotation of the arm causes said ring to screw onto said spindle, and the helical fluting of the spindle, the ring, and the arm enables partial decoupling of rotational motion between the arm and the spindle, such that less torque is required at the beginning and end of a pedal stroke.

In an aspect, the invention comprises a plurality of compression springs positioned around the ring and spindle fluting, wherein the plurality of compression springs counter lateral movement of the ring, providing resistance during pedaling and converting kinetic energy to potential energy during a portion of a pedal stroke and from potential energy to kinetic energy in a later portion of the pedal stroke.

In an aspect, the plurality of compression springs are interchangeable, allowing for adjustment of resistance and potential energy conversion based on cyclist preference and terrain.

In an aspect, the spindle is adapted to fit different bottom brackets, including hollow bottom brackets and tapered bottom brackets, by modifying the central subsection.

In an aspect, the ring includes a threaded end configured to connect to a wingnut, thereby maintaining the connection between the ring and the arm.

In an another aspect, the arm includes a brace ring that interacts with a brace on the left or right disc for lateral stability and strength of the assembly.

In another embodiment, the invention provides a crank assembly system. The system comprises a spindle having a central subsection configured to fit within a hollow bottom bracket, a tube geometry component concentrically nested with the spindle, the tube geometry component having helical fluting configured to enable decoupling of rotational motion between the tube geometry component and the spindle. The system further comprises an arm having a cylindrical tube structure with helical fluting on an inner surface thereof. The arm is configured to receive the tube geometry component in a manner allowing rotational motion therebetween. The rotation of the arm causes the tube geometry component to move laterally, enabling partial decoupling of rotational motion between the arm and the spindle, such that less torque is required at the beginning and end of a pedal stroke.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 and FIG. 2 illustrates a cyclist's pedal stroke torque profile for a standard crank arm stroke, in accordance with an embodiment of the present invention;

FIG. 3 illustrates a conventional crank assembly, in accordance with an embodiment of the present invention;

FIG. 4 illustrates an exploded orientation for the left side of the Axially Decoupled Crank Arm (ADCA), in accordance with an embodiment of the present invention;

FIG. 5 illustrates a schematic view of each of the three primary components of the ADCA, in accordance with an embodiment of the present invention;

FIG. 6 illustrates a cross section of the three primary components of the ADCA in an assembled condition, in accordance with an embodiment of the present invention;

FIG. 7 illustrates a schematic view of connectivity within ADCA components, in accordance with an embodiment of the present invention;

FIG. 8 illustrates an example of the ADCA integrated with other crank system components, in accordance with an embodiment of the present invention;

FIG. 9 illustrates a schematic view of a modified set of components for allowing the ADCA to work with a tapered bottom bracket, in accordance with an embodiment of the present invention;

FIG. 10 illustrates a schematic view of a ringlock for a decoupling modification function of the ADCA, in accordance with an embodiment of the present invention;

FIG. 11 illustrates a schematic view of concentrically nested expanded set of components, in accordance with an embodiment of the present invention;

FIG. 12 illustrates a schematic view of brace nut wrench, in accordance with an embodiment of the present invention;

FIG. 13 illustrates a schematic view of wingnut wrench, in accordance with an embodiment of the present invention;

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

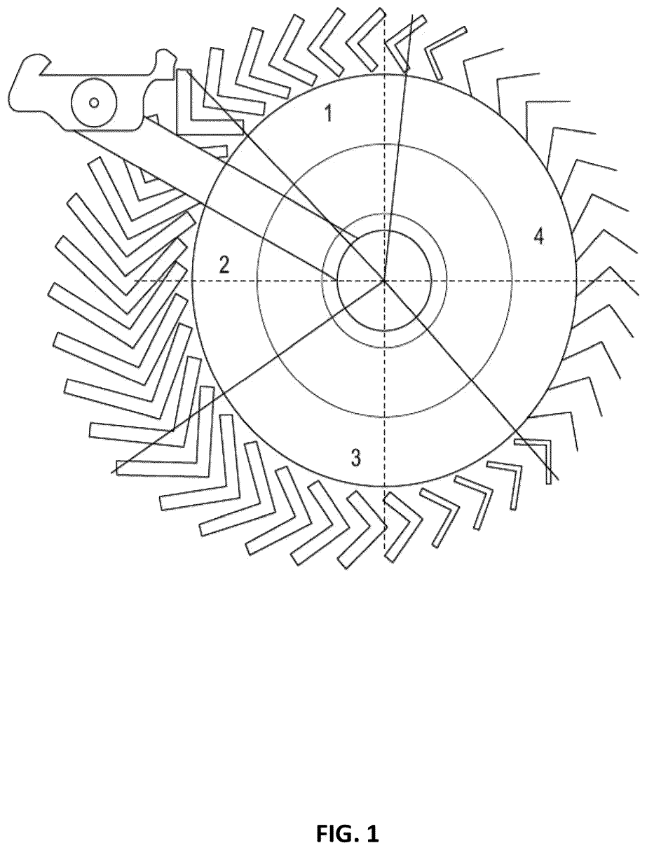

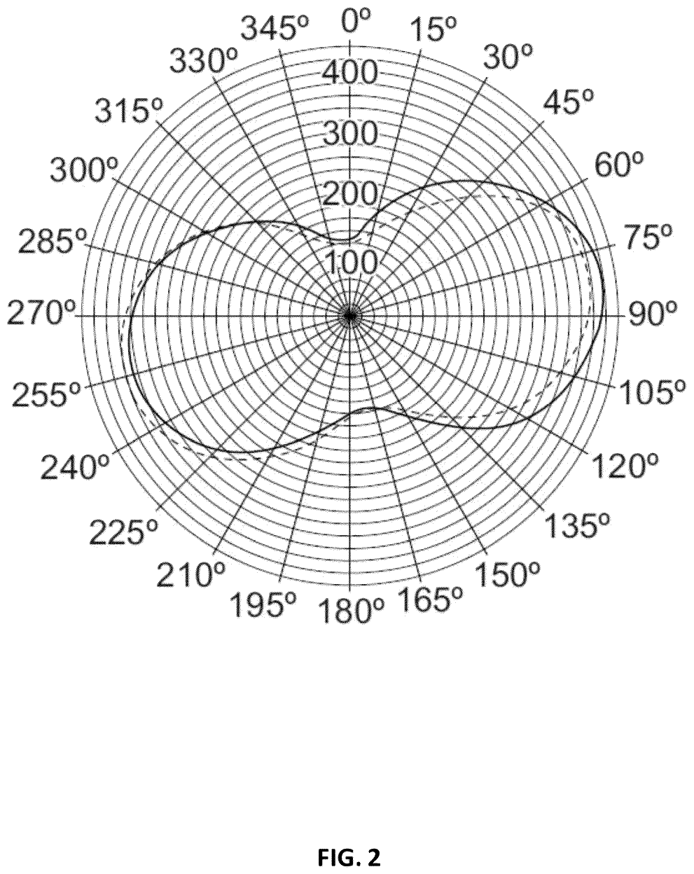

Bicycle pedaling relies on the consistent application of torque to rotate the axle through a full 360° cycle. However, due to the anatomical structure of the human body, particularly the bones, muscles, and joints of the legs, a cyclist cannot exert a uniform amount of torque throughout the entire pedal stroke. Specifically, at the top and bottom of the stroke, approximately 0° and 180° respectively, the cyclist's capacity to generate torque is notably weaker compared to the stronger phase of the stroke, typically around 90°(and around 270° when the other leg is the primary torque source). This torque profile is well-documented and illustrated in FIG. 1 and FIG. 2. These figures provide a graphical depiction of the cyclist's torque exertion over the entire 360° rotation of the pedal stroke. Specifically, they illustrate the fluctuations in torque output, with peaks and troughs corresponding to different phases of the pedal stroke. Such visual representations serve to underscore the non-uniform nature of the torque applied during cycling and emphasize the challenges associated with maintaining consistent power output throughout the pedal revolution.

The implications of this uneven torque distribution are significant. Firstly, it affects the cyclist's ability to smoothly transition from a stationary position to a steady motion, as the weaker phases of the pedal stroke require additional effort to overcome inertia. Secondly, it limits the cyclist's responsiveness to sudden changes in terrain slope, as the weaker phases may result in delays in adjusting pedaling force to match the terrain. Ultimately, this uneven torque profile imposes a constraint on the maximum slope that a cyclist can effectively traverse uphill, as the weaker phases of the pedal stroke may struggle to provide sufficient power against gravity. These limitations highlight the need for innovations that can improve pedal stroke efficiency and overcome the constraints imposed by the human body's biomechanics.

The disclosed invention provides an ADCA which introduces a novel crank assembly system that partially decouples rotational motion between the crank arm and the spindle, reshaping the traditional pedal stroke dynamics. By redistributing torque requirements throughout the pedal stroke, the ADCA improves power transfer and reduces the cyclist's workload at critical points, leading to smoother transitions and enhanced pedaling efficiency. The ADCA represents an innovation in cycling technology, designed to improve pedaling ergonomics, efficiency, and performance. At its core, the ADCA introduces a novel crank assembly system that partially decouples rotational motion between the crank arm and the spindle, reshaping the traditional pedal stroke dynamics. By redistributing torque requirements throughout the pedal stroke, the ADCA improves power transfer and reduces the cyclist's workload at critical points, leading to smoother transitions and enhanced pedaling efficiency.

One of the key features of the ADCA is its ability to adjust torque distribution based on the cyclist's biomechanics and riding preferences. With customizable decoupling levels and adjustable mechanisms for controlling lateral movement and spring tension, cyclists can tailor the ADCA to suit their individual needs, resulting in a more comfortable and personalized riding experience. Whether tackling steep climbs or cruising on flat terrain, cyclists can improve their pedaling dynamics for improved efficiency and performance.

Furthermore, the ADCA offers versatility and adaptability, ensuring compatibility with various bottom bracket configurations and pedal styles. Whether it's a road bike, mountain bike, or pedal-driven machine, the ADCA seamlessly integrates with existing components, allowing cyclists to upgrade their bikes without compatibility concerns. This versatility makes the ADCA accessible to cyclists of all levels, from casual riders to professional athletes, seeking to elevate their riding experience.

With its innovative design and customizable features, the ADCA unlocks the cyclist's full performance potential, enabling higher power outputs, improved speed, and greater endurance. By improving torque distribution and power transfer, cyclists can push their limits and increase performance on the bike, regardless of the terrain or riding conditions. Moreover, the ADCA enhances riding comfort by reducing fatigue and reducing stress on the cyclist's legs and joints, ensuring a more enjoyable and fulfilling riding experience.

In an embodiment, the ADCA introduces a transformative mechanism that redefines the conventional pedal stroke dynamics in cycling. By partially decoupling the rotational motion of the crank arm from that of the axle, the ADCA revolutionizes how cyclists interact with their bikes. This decoupling mechanism is meticulously engineered to improve pedaling ergonomics and efficiency, addressing the inherent limitations of traditional crank arm assemblies. As a result, cyclists experience reduced torque requirements at both the top and bottom of the pedal stroke, alleviating strain on their muscles and joints and enhancing overall riding comfort.

Central to the innovation of the ADCA is its ability to modify the stroke profile, shifting from a conventional pattern of consistent resistance throughout the 360° rotation of the axle to a dynamic profile where resistance varies. This variation in resistance enables cyclists to exert less effort during phases of the pedal stroke where biomechanical advantages are diminished, such as at the top and bottom dead centers. By adapting the resistance profile to match the cyclist's natural biomechanics, the ADCA improves power transfer and reduces energy wastage, resulting in smoother pedaling motion and improved efficiency.

Furthermore, the decoupling mechanism of the ADCA not only reduces the required torque but also enhances the overall riding experience by promoting a more natural and fluid pedaling motion. Cyclists can maintain a steady cadence with less effort, allowing for prolonged rides with reduced fatigue. This innovative approach to crank arm design represents a significant advancement in cycling technology, offering cyclists of all levels a more comfortable, efficient, and enjoyable riding experience.

In an embodiment, the variant stroke profile introduced by the ADCA is meticulously engineered to improve pedaling dynamics and efficiency throughout the entire pedal stroke. Divided into three distinct phases, this innovative profile redefines how cyclists generate and transfer power during their rides. Phase 1, known as the Slide Forward or Spring-loading phase, encompasses the initial 0° to approximately 15° of the pedal stroke. During this phase, the crank arm experiences minimal resistance as it moves forward, allowing the cyclist to preload the spring mechanism and store potential energy for subsequent phases.

Following Phase 1 is Phase 2, the Power Phase, which extends from the end of Phase 1 to approximately 110°-150° of the pedal stroke. This phase represents the primary exertion of force by the cyclist, as they apply maximum torque to propel the bike forward. The ADCA improves the power transfer during this phase, ensuring efficient energy utilization and increasing propulsion. As the cyclist reaches the latter stages of Phase 2, the transition to Phase 3, the Slide Return or Spring-expansion phase, begins.

Phase 3 covers the final segment of the pedal stroke, from the end of Phase 2 to approximately 180°. During this phase, the stored potential energy from Phase 1 is released, assisting in the return motion of the crank arm and providing additional rotational force. The ADCA's innovative design facilitates a smooth transition between these phases, ensuring a seamless and efficient pedaling motion. It's important to note that while these phases provide a general framework, the exact transition points may vary depending on individual cyclist biomechanics and riding techniques, highlighting the adaptability and versatility of the ADCA's stroke profile.

The ADCA introduces a revolutionary concept in pedaling mechanics, fundamentally altering the distribution of work across the pedal stroke. A key innovation of the ADCA is its ability to improve the efficiency of pedaling by redistributing the workload between different phases of the stroke. This redistribution is particularly evident in Phase 1 and Phase 3, where the ADCA decreases the amount of work required per degree of rotation compared to Phase 2.

During Phase 1 and Phase 3, the ADCA operates on a principle of accommodating the body's reduced torqueing capacity and reducing resistance. This results in a reduced workload for the cyclist during these phases, as less torque is needed to maintain momentum and initiate the pedal stroke. By contrast, Phase 2 represents the peak exertion phase, where the cyclist applies maximal force to generate power and propel the bike forward. The ADCA shifts the majority of the workload to Phase 2, capitalizing on the body's greater capacity to create torque during this segment of the pedal stroke.

This strategic redistribution of work enables the ADCA to improve energy expenditure and enhance pedaling efficiency. By reducing the workload during Phase 1 and Phase 3, where the body has less capacity to create torque, and concentrating effort during Phase 2, where torque generation is greater, the ADCA ensures that the cyclist can increase power output while decreasing fatigue. This innovative approach not only improves overall performance but also enhances rider comfort and endurance, making cycling more enjoyable and accessible for cyclists of all levels.

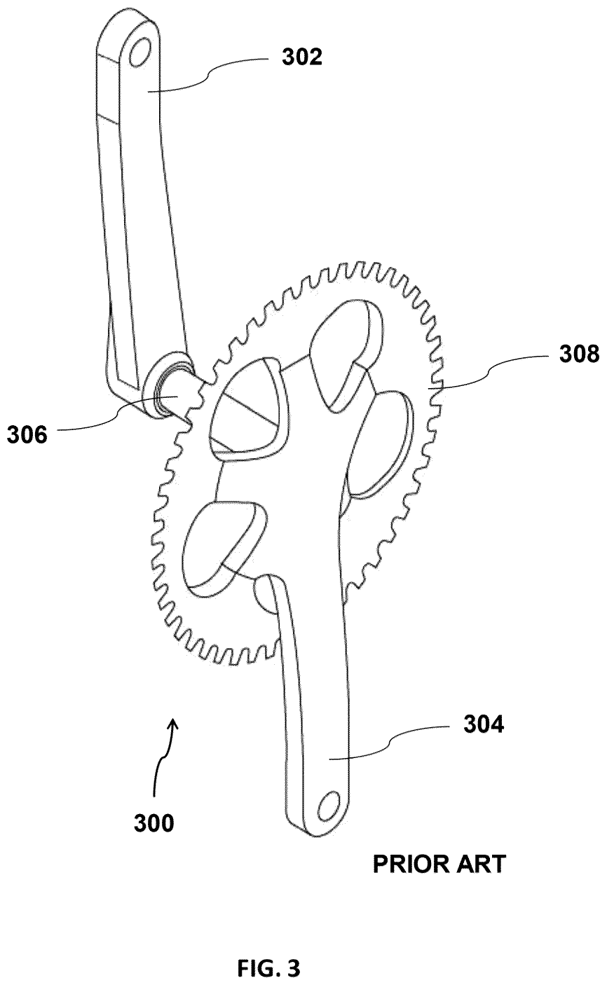

FIG. 3 shows a conventional crank assembly compatible with a hollow bottom bracket 300 that includes a crank arm, i.e., a left arm 302 and a right arm 304 for the left and the right pedals and a crank spindle (axel) 306. The crank assembly 300 comprises crank arms 302, 304 for both the left and right pedals, interconnected by a central crank spindle (axle) 306. Integral to this assembly are various other components constituting the broader conventional cranking system, including pedals, chain rings 308, a chain, a bottom bracket (BB), and the bicycle frame itself. Together, these components form the foundation of the bicycle's power transmission mechanism.

The ADCA represents a transformative advancement in crank assembly design, poised to supersede traditional configurations such as the one depicted in FIG. 3. Designed with compatibility in mind, the ADCA serves as a direct replacement for conventional crank assemblies, seamlessly integrating with existing cranking system components. Notably, the ADCA is engineered to accommodate a diverse range of configurations, including chain rings with varying bolt-hole patterns and bottom brackets of differing types, such as hollow BBs, tapered BBs, and BBs of various lengths and diameters.

By ensuring compatibility with a myriad of cranking system components, the ADCA offers cyclists flexibility and versatility in upgrading their bicycles. Whether it's adapting to different chain ring configurations or accommodating various bottom bracket standards, the ADCA empowers cyclists to tailor their bikes to their specific preferences and performance requirements. This compatibility with a wide array of components underscores the ADCA's status as a solution for enhancing cycling performance and efficiency.

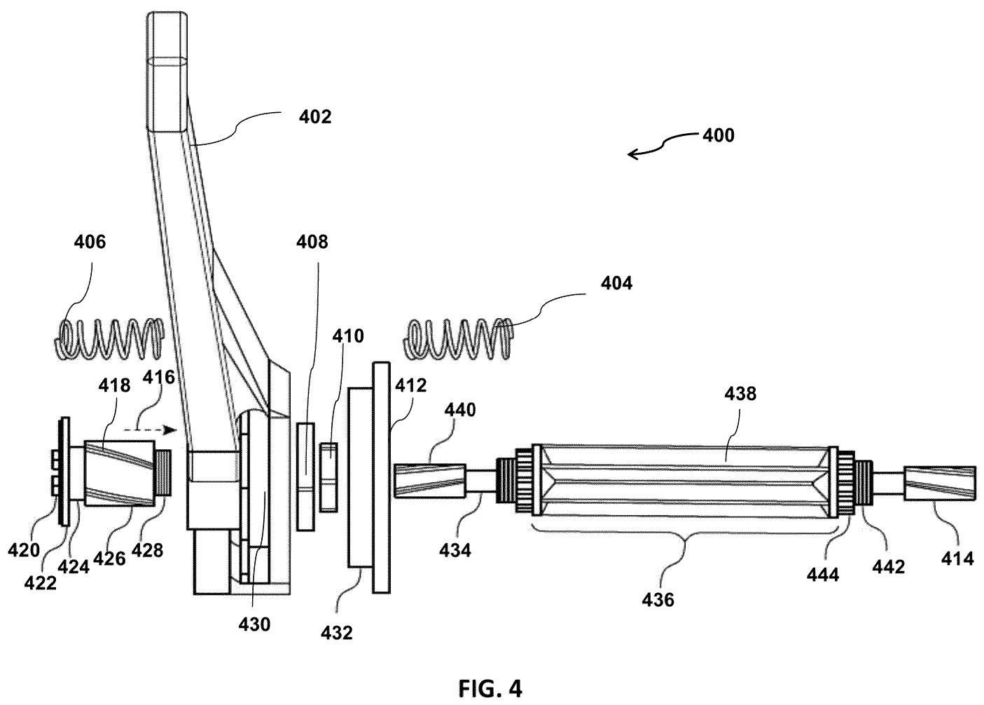

In accordance with an embodiment of the present invention, FIG. 4 shows orientation (exploded) for the left side of the ADCA assembly 400 as implemented in various embodiments. This exploded view provides a comprehensive illustration of the intricate arrangement of parts that constitute the ADCA. While FIG. 4 specifically depicts the left side of the assembly, it is noted that the right side mirrors this configuration, albeit with slight variations to accommodate the chain ring connecting bolt-hole structure integrated into Disc-Right 712.

The ADCA assembly, as depicted in FIG. 4 and other accompanying figures, is meticulously engineered to fulfill its primary function: facilitating rotational motion of the Arm that is partially decoupled from the rotational motion of the Spindle. This essential function is achieved through the coordinated interaction of three primary components: the Arm 402, the Ring 418, and the Spindle 438. As the cyclist applies force to the pedal, initiating the pedaling motion, the Arm is set in rotation. This rotational motion is transmitted to the Spindle via the interconnected components, with the Ring 420 serving as a pivotal intermediary element.

Throughout various embodiments, the ADCA assembly is designed to improve the performance and efficiency, ensuring seamless operation during cycling. By decoupling the rotational motion of the Arm from that of the Spindle, the ADCA reduces resistance and torque requirements, enhancing the overall pedaling experience for cyclists. This innovative design allows for smoother, more fluid pedaling motion, ultimately improving rider comfort and performance. As cyclists engage in pedaling, the ADCA's intricate arrangement of components facilitates an improved transfer of power, resulting in enhanced cycling dynamics and increased efficiency.

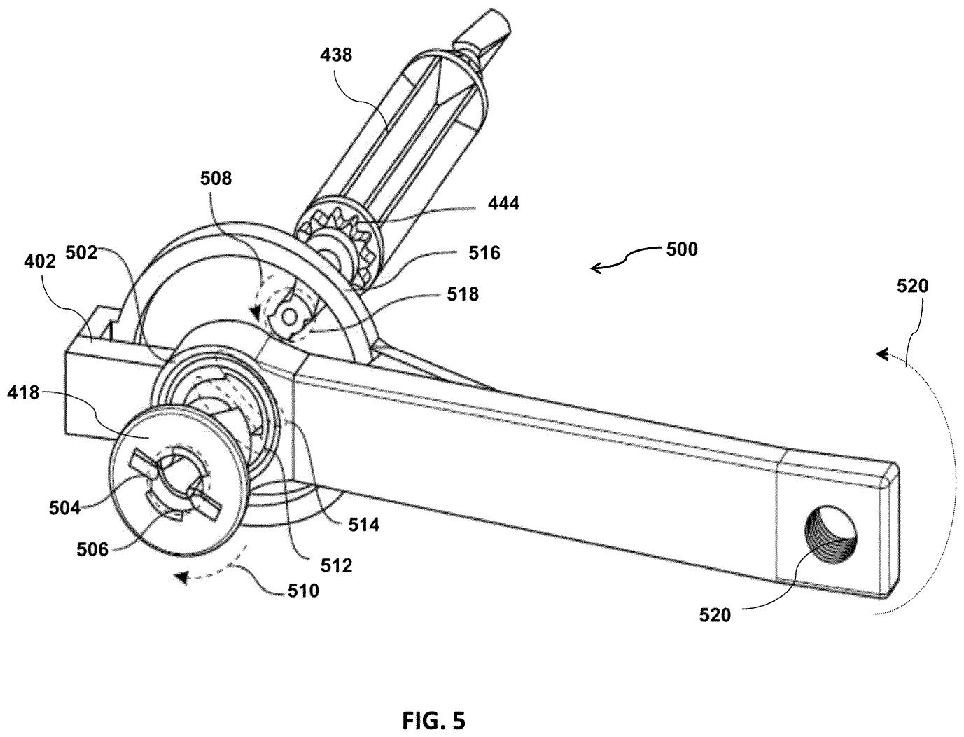

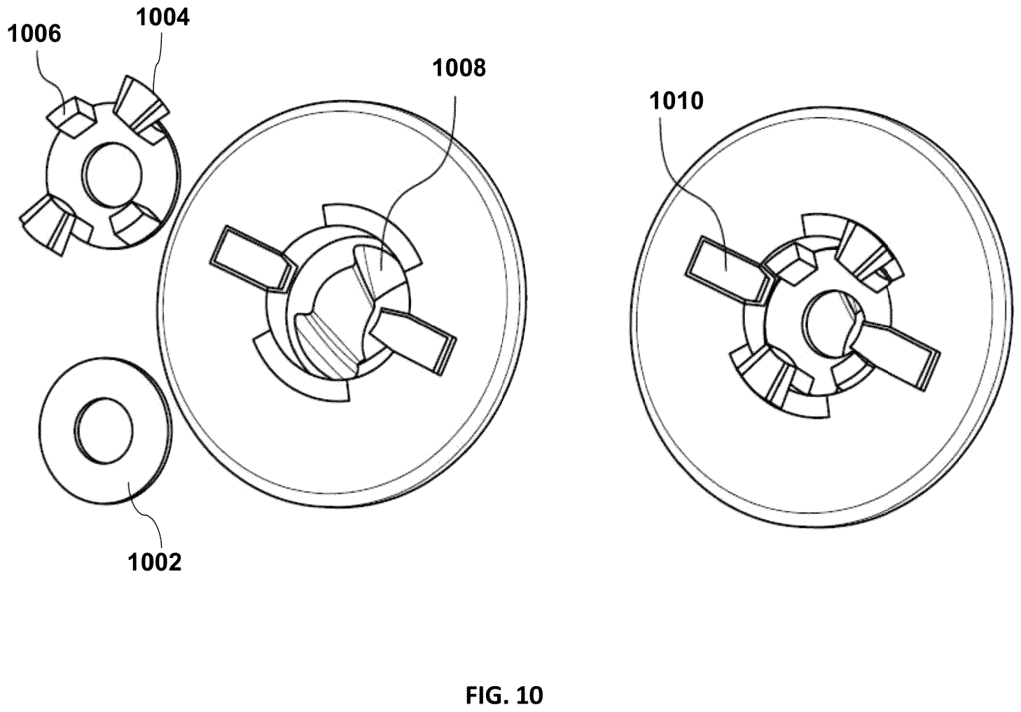

In accordance with an embodiment of the present invention, FIG. 5 shows that each of the three primary components (Spindle, Ring and Arm) includes outside cylindrical and/or inner tube sections with two helical flutes. This figure provides a detailed illustration of the three primary components of the ADCA assembly: the Spindle, the Ring, and the Arm. Each of these components exhibits a cylindrical structure adorned with two helical flutes, denoting a critical aspect of the ADCA's design. Specifically, the Spindle features a cylindrical section with helical fluting, as evidenced by references 414, 440 in FIG. 4, and 518 in FIG. 5. Similarly, the Ring showcases a cylindrical tube with helical fluting on both its inner and outer surfaces, depicted in references 506 and 512 in FIGS. 5 and 1008 FIG. 10.

Furthermore, the Arm also incorporates a cylindrical subsection with helical fluting on its inner surface, as depicted by reference 514 in FIG. 5. When these three primary components are assembled together, the fluted subsection of the Spindle seamlessly fits within the inner tubing of the Ring, ensuring a snug and precise connection. Notably, the orientation of the fluting on the Spindle and the Ring is such that the ring rotates counterclockwise relative to the spindle when viewed from the left side of the assembly in FIG. 5, maintaining consistency in rotational directionality.

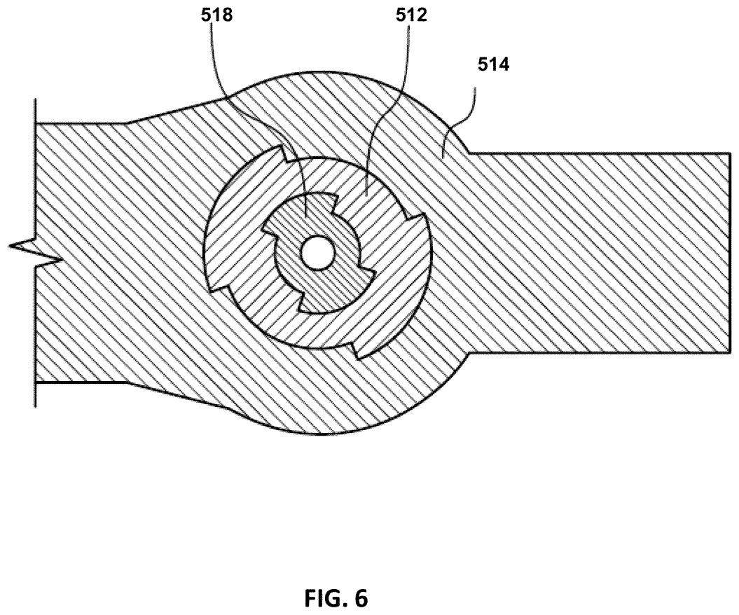

Similarly, the Arm and the Ring feature paired fluted cylindrical surfaces, with the outer fluted subsection of the Ring fitting snugly within the inner fluted tubing of the Arm. Notably, when viewed from the left side of the assembly, as depicted in FIG. 5, the fluting on both the Ring's outer surface and the Arm's inner surface rotates clockwise, aligning with the rotational directionality established by the Spindle and the Ring. This meticulous design ensures smooth interaction between the components, facilitated by a small allowance between them, allowing for seamless movement within each other, typically aided by lubrication. FIG. 6 further elucidates the intricate arrangement of these components in a cross-sectional view when assembled together, providing a comprehensive understanding of their interplay within the ADCA assembly.

In accordance with an embodiment of the present invention, FIG. 6 depicts a description of the resulting motion of the three primary components as the cyclist pedals. This figure offers a comprehensive visualization of the intricate interplay between the three primary components of the ADCA assembly during a cyclist's pedaling motion. As the cyclist initiates the pedal stroke with her left leg, the Arm undergoes a counterclockwise rotation, as indicated by reference 520 in FIG. 5. This rotational movement of the Arm triggers a paired fitting mechanism between the Arm and the Ring, causing the Ring to thread into the Arm in a clockwise motion relative to the Arm, leading to lateral movement towards the center of the assembly, as depicted by reference 510 in FIG. 5 and reference 416 in FIG. 4.

Simultaneously, as the Ring moves laterally towards the center, the combination of the Ring and the Arm executes a counterclockwise rotation relative to the Spindle, facilitated by the threading action of the Ring onto the Spindle, as depicted by reference 508 in FIG. 5. It's important to note the dual contribution to the counterclockwise rotation of the Arm relative to the Spindle during this phase of the pedal stroke. Consequently, during Phase 1, the Arm can undergo a significant counterclockwise rotation with minimal resistance, all while the Spindle remains relatively stationary, decoupling the Arm's motion from the Spindle.

This nuanced motion allows for a smooth and efficient transfer of power from the cyclist's pedal stroke to the crank assembly, optimizing energy utilization and enhancing cycling performance. By decoupling the rotational motion of the Arm from the Spindle during specific phases of the pedal stroke, the ADCA enables cyclists to generate torque more effectively, resulting in a more fluid and ergonomic cycling experience.

The helical fluting design illustrated in the figures showcases a specific rotational characteristic, where each millimeter of lateral movement along the cylindrical surface corresponds to a 2-degree rotation for each of the three primary components. For instance, if the design dictates a lateral constraint of 5 millimeters for the Ring's movement, this translates to 10 degrees of rotation attributed to the interaction between the Arm and the Ring, combined with an additional 10 degrees resulting from the interaction between the Ring and the Spindle. Consequently, the total rotation of the Arm relative to the Spindle can reach 20 degrees, offering flexibility in design configurations. This feature enables the Arm to rotate independently of the Spindle, allowing for tailored adjustments to accommodate various cycling preferences and enhances performance. Note that variations in the helical fluting design (e.g., other than the depicted 2°/mm) can vary the range of decoupling.

In the initial phase of the pedal stroke, known as Phase 1, the cyclist can, with little effort, rotate the Arm by up to 20 degrees, encountering minimal resistance due to the unique design facilitating independent movement. However, this absence of resistance during Phase 1 may lead to a jarring and unnatural cycling experience for the rider. To address this issue, an enhancement to the mechanism involves integrating compression springs, with two springs positioned on the left side and two positioned on the right side of the assembly. These springs play a crucial role in counteracting the lateral movement of the Ring, ensuring a smoother and more controlled transition between pedal strokes.

By strategically placing the compression springs, they effectively mitigate the abruptness associated with the initial phase of the pedal stroke, offering a more fluid cycling motion. As the cyclist applies force to the pedal, the springs exert pressure to stabilize the lateral movement of the Ring, thereby introducing a consistent level of resistance throughout the pedal stroke. This refinement enhances the overall riding experience by providing a natural and harmonious interaction between the cyclist and the pedal assembly, ensuring comfort and performance.

The integration of compression springs represents a key advancement in pedal assembly design, addressing the need for smoother transitions between pedal strokes while maintaining peak efficiency and control. This innovative feature underscores the commitment to enhancing cyclist comfort and ergonomics, ultimately contributing to a more enjoyable and effective cycling experience.

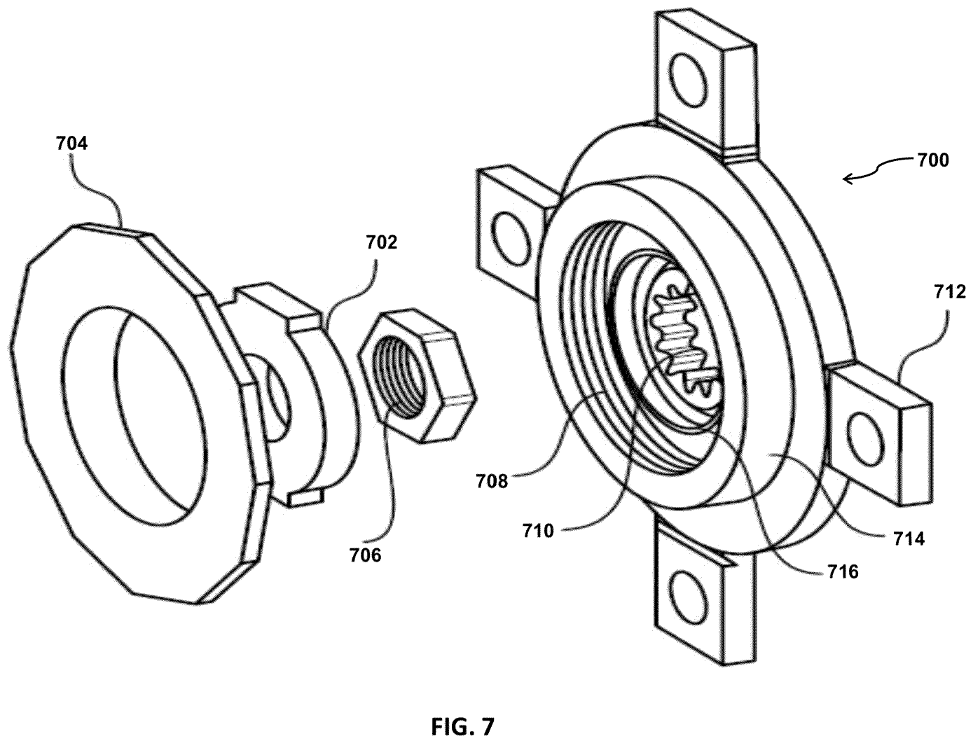

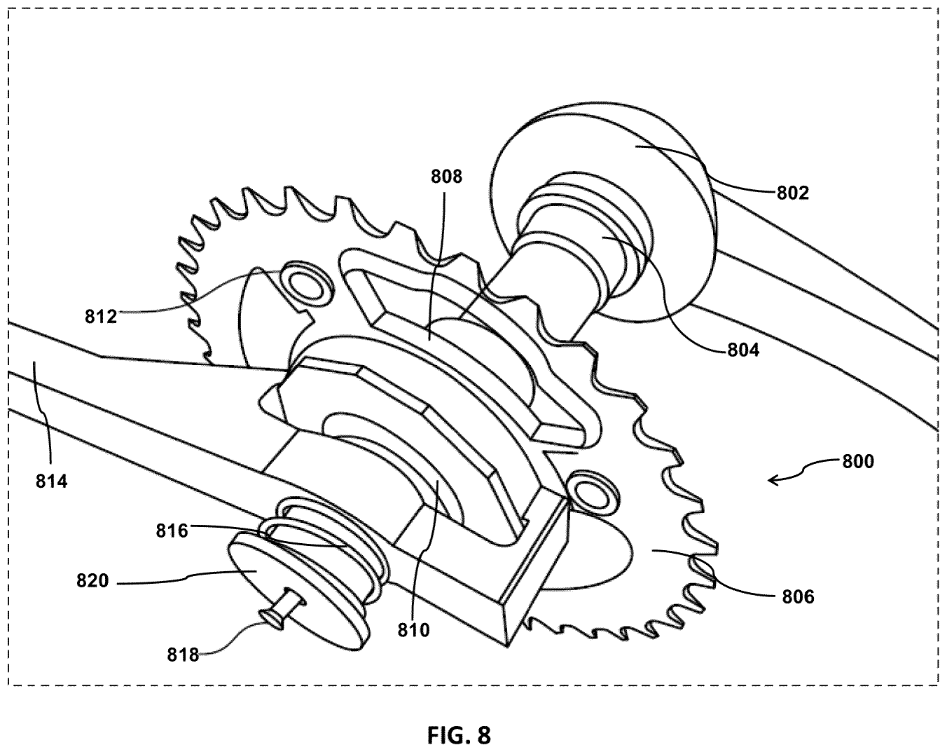

These compression springs are placed around the fluted cylinder of the left and right Rings as well as around the fluted cylinders on the spindle. One end of a spring will rest in a circular groove in the end cap 422 (FIG. 4) of the Ring. The other end of this spring will rest in a similar groove in the Arm 502 (FIG. 5). This Spring Outside-Right is labeled as 816 in FIG. 8. The Spring Inside-Right is identical and its location is also shown as 810 in FIG. 8. The inside spring rests one end in a similar groove in the Wingnut 702 as shown in FIG. 7 and in a similar groove in the Disc 716 (FIG. 7). The inside-outside spring configuration is identical on the left and the right. Both of the springs on one side are compressed when the Ring on that side moves laterally. The presence of the springs has three positive effects:
They provide a consistent and more natural resistance for the cyclist's motion (but less resistance than the general resistance of rotating the spindle with conventional crank arms),
They allow the conversion of kinetic energy to potential energy in Phase 1,
This potential energy is converted back to kinetic energy in Phase 3 of the stroke cycle when the springs expand which adds additional rotational force during this other stroke phase when the cyclist cannot provide a high level of torque.
   As an alternative to a standard compression spring another type of compressible/expandable tube-shaped structure could be used such as a biaxially or triaxially braided tube structure.

During the cycling motion, Phase 3 of one leg's stroke partially coincides with Phase 1 of the other leg's stroke, resulting in a partial overlap. This overlapping period presents a unique opportunity where the potential energy accumulated by one leg during Phase 1 can be effectively utilized to initiate the rotation of the other leg's pedal during its Phase 1. Consequently, this synchronization allows for a seamless transfer of energy between the two legs, enabling one leg to supplement the work performed by the other leg throughout a complete rotation. This cooperative action improves the overall efficiency of the cycling motion, ensuring a more balanced and consistent pedal stroke.

Furthermore, the adaptability of the pedal assembly is enhanced by the capability to interchange the compression springs. Cyclists with varying strength levels can customize their riding experience by selecting compression springs that align with their individual preferences and capabilities. For instance, weaker cyclists may opt for weaker springs to reduce the amount of effort required during Phase 1, thereby enhancing comfort and reducing fatigue. Conversely, cyclists seeking to enhance the performance can utilize stronger springs to challenge themselves and achieve a more rigorous workout. Additionally, the option to use different spring strengths for each leg offers further customization possibilities, allowing cyclists to fine-tune their pedal assembly setup based on their unique cycling goals and biomechanical characteristics including accommodating legs with different strengths and cycling goals. This versatility underscores the pedal assembly's ability to accommodate a diverse range of riders while promoting comfort, efficiency, and performance.

In an embodiment, the symmetrical design of the pedal assembly ensures uniform functionality and performance on both the left and right sides of the bicycle. This symmetry is evident in the mirroring of the helical fluting patterns across corresponding components. For instance, on the Spindle, the fluting configuration observed on the right side is an exact reflection of that on the left side, as depicted in FIGS. 4 and 5. Similarly, the Arm and Ring assemblies for the right side are mirror images of their counterparts on the left side. This meticulous attention to symmetry is essential to accommodate the clockwise rotation of the right arm relative to the Spindle when viewed from the right side of the bicycle.

At the initiation of the pedal stroke, the cyclist can rotate the Arm approximately 20° without inducing any movement in the Spindle. Although the cyclist's exerted torque does contribute to the rotation of the Spindle to some extent during Phase 1, this effect is notably reduced compared to conventional crank arm systems. Instead, a portion of the cyclist's effort in Phase 1 is diverted towards compressing the springs and generating potential energy. The precise distribution of work between rotating the Spindle and compressing the springs varies depending on factors such as terrain, cycling technique, and individual preferences. This adaptable allocation of work ensures more optimal energy utilization and enhances the cyclist's overall riding experience, regardless of environmental conditions or riding style.

The below mentioned features relate to connectivity within ADCA components, connectivity with outside crank system components, strengthening and assembly needs. Features related to connectivity within ADCA components include in various embodiments:

Once the central Spindle subsection (BB Fitting) 436 (FIG. 4) is correctly inserted and secured within the Hollow BB, the left and right Discs 710 (FIG. 7) are meticulously placed onto the splines located on the Spindle 444 (FIG. 4 and FIG. 5). This snug fitting of the Discs onto the splines ensures precise alignment and stability of the Spindle within the bottom bracket assembly. By securely affixing the Discs onto the Spindle, any potential for unwanted movement or misalignment of the Spindle during cycling is effectively decreases. This robust connection between the Discs and the Spindle contributes to the overall structural integrity and performance of the ADCA, enhancing its reliability and longevity during use.

The tapped threaded Spindlenuts 410 (FIG. 4) and 706 (FIG. 7) play a crucial role in the secure installation of the ADCA within the bottom bracket assembly. Positioned on both the left and right sides, these Spindlenuts are meticulously bolted onto the threading 442 (FIG. 4) present on the Spindle. By firmly securing the Spindle in its designated position within the bottom bracket, the Spindlenuts ensure the proper alignment and stability of the entire crank assembly during operation. Additionally, the Spindlenuts exert pressure on the Discs, effectively holding them in place and preventing any unwanted movement or dislodgement during cycling. The spindlenut may make use of a split lock washer or internal nylon coating to aid in resistance to vibration. This robust fastening mechanism not only enhances the overall structural integrity of the ADCA but also contributes to its smooth and reliable performance, minimizing the risk of mechanical issues or malfunctions during use.

The threaded end 428 (FIG. 4) of the Ring serves as a pivotal connection point within the ADCA assembly, facilitating the integration of crucial components for its operation. This threaded end securely fastens to a corresponding tapped thread in the Ringnut 408 (FIG. 4) and 702 (FIG. 7), creating a stable linkage that reinforces the structural integrity of the entire system. This connection not only ensures the proper alignment and engagement of the Ring with other components but also enables seamless transmission of forces and motions during pedaling. By effectively joining the Ring to the Ringnut through threaded engagement, the ADCA maintains its stability and functionality, allowing for smooth and efficient operation without the risk of component detachment or misalignment.

The attachment of the Ringnut plays a crucial role in maintaining the cohesion and functionality of the ADCA system. By securely fastening the Ring to the Arm, the Ringnut ensures that these components remain interconnected and operate harmoniously during the pedaling process. Additionally, the presence of the Ringnut helps to retain the outer spring in a partially compressed state, contributing to the overall stability and performance of the mechanism. This compression of the spring is essential for storing potential energy generated during the pedal stroke, which can then be utilized to augment the cyclist's effort and enhance the efficiency of the system. Thus, the attachment of the Ringnut serves as a pivotal element in optimizing the functionality and effectiveness of the ADCA, ensuring smooth and reliable operation throughout the cycling experience.

The presence of the brace and brace ring 516 (FIG. 5) on the Arm serves multiple crucial functions within the ADCA system. By fitting snugly over a corresponding ring on the Disc 432 (FIG. 4) and 714 (FIG. 7), the brace ring ensures proper alignment and stability, maintaining the lateral position of the Arm relative to the Spindle during the pedaling motion. This alignment is essential for the smooth and efficient operation of the mechanism, preventing unwanted lateral movement or misalignment that could compromise performance. Additionally, the brace and brace ring combination adds structural strength to the ADCA assembly, enhancing its durability and robustness during rigorous cycling activities. As the outer ring rotates around the inner ring in tandem with the pedaling motion, the brace and brace ring play a pivotal role in ensuring the integrity and stability of the entire system, thereby contributing to a more reliable and effective cycling experience.

The Bracenut 430 (FIG. 4) and 704 (FIG. 7) serves as a critical component within the ADCA system, responsible for securing the Arm's brace ring in a fixed lateral position relative to the Spindle. With its threaded lip, the Bracenut securely attaches to the tapped threading within the Disc, forming a stable connection that prevents any lateral movement or displacement of the Arm during operation. The Bracenut may be further secured to the Disc by way of a cotter pin inserted through holes in both the Bracenut and the Disc. By holding the brace ring firmly in place, the Bracenut ensures consistent alignment and stability, contributing to the smooth and efficient functioning of the ADCA assembly. This fixed lateral position of the Arm is essential for maintaining proper alignment and coordination between the various components, ultimately optimizing the performance and reliability of the cycling mechanism. Thus, the Bracenut plays a crucial role in enhancing the overall functionality and effectiveness of the ADCA system, providing cyclists with a more seamless and enjoyable riding experience.

The small screw 818 (FIG. 8), accompanied by a metal flat washer and a rubber washer, constitutes an optional mechanism that supports constraining the movement of the Ring. This screw facilitates the attachment of a Ringlock described subsequently.

The above features are listed roughly in order of system assembly. Some component features were designed to facilitate assembly. Additional features facilitate connectivity and integration with crank system components beyond the ADCA. FIG. 8 shows an example of the ADCA integrated with other crank system components including a chain ring 806 and a hollow bottom bracket 804 as shown in FIG. 8.

In an embodiment, the Spindle constitutes a pivotal element in the ADCA system, meticulously engineered to seamlessly integrate into a hollow bottom bracket, ensuring a precise and secure fit. A subcomponent of the spindle, known as the BB Fitting, and denoted as subsection 436 in FIG. 4, embodies a high degree of versatility, as it can be customized to varying lengths and diameters to accommodate a diverse array of hollow bottom brackets. This adaptability is instrumental in catering to different brands or styles of hollow bottom brackets, including both pressed and threaded configurations, thereby offering cyclists the flexibility to choose the most suitable option for their specific bicycle setup. Importantly, modifying the spindle with a different BB Fitting is the sole adjustment required to accommodate various hollow brackets, as all other components of the ADCA system remain universally compatible. This streamlined approach simplifies the customization process and ensures seamless integration, allowing cyclists to enhance their riding experience with minimal hassle or modification.

The Disc-Right component within the ADCA system plays a pivotal role in facilitating the attachment of a bolt circle diameter (BCD) chainring, utilizing standard hardware commonly included with such chainrings, as depicted by structure 712 in FIG. 7. FIG. 8 shows the Disc-Right 808 connected to a chainring 806 with standard hardware 812. This structural design enables seamless integration with various BCD chainring configurations, ensuring compatibility with the standard hardware typically provided with these components. Moreover, the Disc-Right offers a high degree of adaptability, as it can be modified to accommodate different styles of chainrings, such as those featuring varying bolt-hole configurations or asymmetric arrangements. Additionally, adjustments can be made to the bolt-hole structures to align with specific chainline specifications, further enhancing the versatility and customization options of the ADCA system. Importantly, these modifications are confined to the Disc-Right component, simplifying the process of accommodating different chainring styles and chainline requirements without necessitating alterations to other ADCA elements. This streamlined approach underscores the system's versatility and ability to cater to cyclists' diverse preferences and riding needs with minimal adjustments.

The integration of both inside and outside springs within the Rings and Spindle of the ADCA system necessitates specific structural features to effectively accommodate these pre-compressed springs. Within the Rings, denoted as structure 424 in FIG. 4, and the Spindle, illustrated as structure 434 in the same figure, designated spaces or recesses are incorporated to house the pre-loaded springs securely. These structural provisions ensure that the springs are effectively positioned and maintained within the assembly, contributing to the system's operational integrity and performance consistency. Furthermore, the design allows for flexibility in spring selection, as different springs with varied strengths or loads can be readily substituted to tailor the ADCA's performance characteristics to meet specific user preferences or cycling requirements. This adaptability empowers cyclists to fine-tune the ADCA system according to their individual preferences, riding style, or terrain conditions, enhancing the overall versatility and usability of the innovative cycling technology.

In an embodiment, the Arms of the ADCA system are equipped with threaded holes, as indicated by reference number 520 in FIG. 5, designed specifically to facilitate the secure attachment of pedals. This threaded configuration ensures a stable and reliable connection between the pedals and the Arms, minimizing the risk of detachment or instability during use. Importantly, this feature enables compatibility with various styles of pedals, encompassing both clipped and non-clipped variants commonly preferred by cyclists. Whether cyclists opt for clipped pedals for enhanced efficiency and power transfer or non-clipped pedals for greater versatility and ease of use, the ADCA system accommodates their preferences seamlessly. The threading hole in the Arm can be easily modified to accommodate pedals with bolts of different diameter or threading. By supporting multiple pedal styles, the ADCA enhances its applicability to a broader range of cycling disciplines, catering to the diverse needs and preferences of riders across different skill levels and cycling activities.

The general design of the ADCA includes the means to adapt it easily to different styles of adjacent components (hollow BBs, chainrings, pedals) by swapping in a different Spindle or Disc-Right as described above. The component modifications described above to accommodate different adjacent components can be regarded as different embodiments. Below mentioned are additional alternative embodiments of the present invention:

In an embodiment, while the central subsection of the Spindle, denoted as the BB Fitting and depicted as reference number 436 in FIG. 4, is shown with a particular geometry in the illustrated figures, it's essential to note that alternative configurations are entirely feasible. For instance, instead of the finned design showcased, a solid cylinder could be employed for the Spindle's central section. However, the illustrated structure, with its hollow interior, offers distinct advantages, particularly in terms of weight reduction. By incorporating less material than a solid counterpart, this design choice result in a lighter overall assembly, this can be advantageous for cyclists seeking enhanced performance and maneuverability. The reduced weight contributes to improved efficiency and agility during cycling activities, allowing riders to exert less effort when pedaling and enabling smoother and more responsive handling of the bicycle. Therefore, while alternative geometries are conceivable for the Spindle's central subsection, the depicted finned configuration offers tangible benefits in terms of weight optimization and overall performance enhancement. Note that weight could be further reduced by reducing the number of fins and/or the size and shape of the fins (e.g., fins that don't extend to the center axis of the spindle).

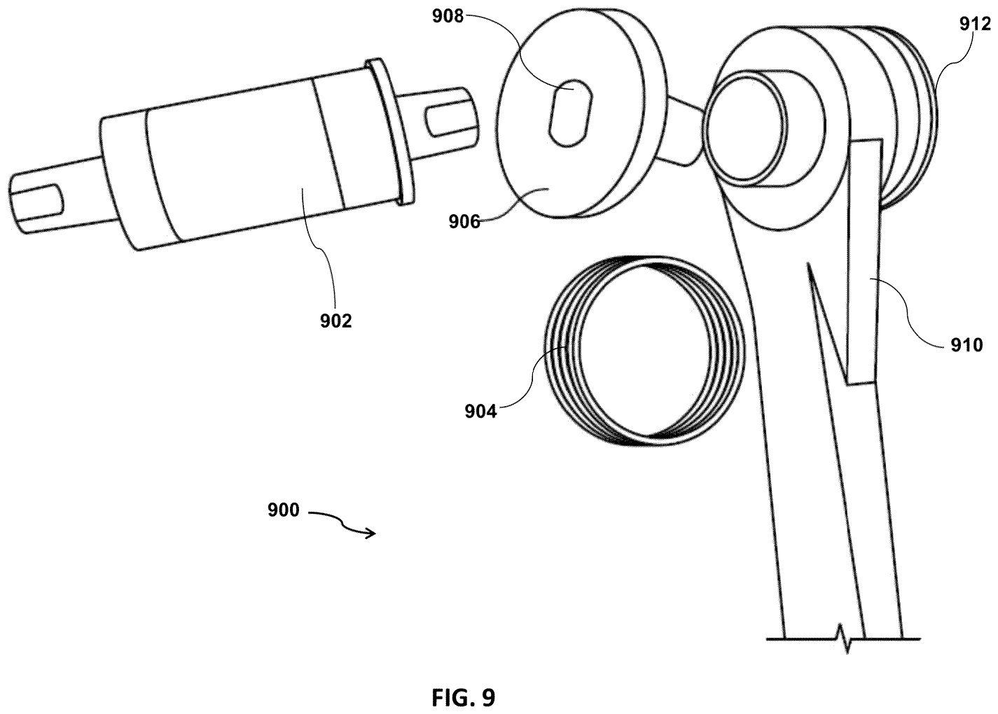

In an embodiment, in the variant of the Adjustable Decoupling Crank Assembly (ADCA) designed to accommodate a tapered bottom bracket (BB), certain modifications to the components are necessary, as illustrated in FIG. 9. The tapered BB embodiment differs from the hollow BB embodiment in a significant way. Rather than the spindle component attached to discs with spindlenuts (as with the hollow BB embodiment) a left and right disc (which includes the helically fluted cylinder integrated) are attached with a screw over the tapered section of the solid tapered BB; each disc having a tapered hole that matches the BB and providing for a snug fit. The illustration depicts a specialized configuration tailored for compatibility with a tapered bottom bracket 902. The components visible in the diagram include the left disc 906, the ring 912, and the arm 910, which form integral parts of the crank assembly system. Additionally, a spring 904 is illustrated, serving a crucial role in the assembly's functionality. Notably, the figure showcases integrated Disc-axels with a cut-out space 908, strategically designed to snugly fit the tapered section of the bottom bracket. This snug fit ensures improved alignment and stability, enhancing the overall performance and durability of the assembly. Unlike the standard hollow BB configuration intended for use with a hollow bottom bracket, this version features integrated Disc-axels (with fluted cylinders integrated) with a specific design tailored to fit snugly around the tapered section of the BB. This snug fit ensures stability and proper alignment of the ADCA within the tapered BB, enhancing the overall performance and functionality of the assembly. Additionally, a screw is utilized to secure the ADCA in place, passing through the Ring component and into the bolt hole located in the tapered BB. Notably, in this embodiment, several components, including the fluted cylinders and the springs, exhibit a slightly larger diameter compared to their counterparts in the standard hollow BB ADCA configuration. This adjustment in size ensures compatibility and improved functionality within the tapered BB setup, providing cyclists with a reliable and efficient crank assembly solution tailored to their specific bicycle frame requirements.

In accordance with an embodiment of the present invention, to accommodate preferences for specific Q-factors the angle of the arm could be changed and/or the length of the rings and corresponding components could be changed.

In an embodiment, to provide cyclists with flexibility in adjusting the functionality of the Adjustable Decoupling Crank Assembly (ADCA) during their ride, a mechanism called the Ringlock is introduced as an optional feature. In FIG. 10, several components crucial to the crank assembly system are highlighted. These include a washer, which serves as a stabilizing element within the assembly. Additionally, a left ringlock 1004 is depicted, which is a key component in controlling the decoupling function of the assembly. The illustration also showcases specific features such as the ringlock nub 1006 and the ring nub 1010, which interact to enable or disable the decoupling mechanism. Furthermore, the figure displays helical fluting 1008, a characteristic feature of the assembly's components, contributing to the system's functionality and efficiency. Illustrated in FIG. 10, the Ringlock replaces the standard flat washer through which the securing screw passes. In its default position, depicted on the right side of FIG. 10, the Ringlock allows the ADCA to function in its standard mode, with the decoupling feature operational as previously described. However, cyclists have the option to engage the Ringlock by rotating it counter-clockwise approximately 30°. This action positions the nub of the Ringlock beneath and against the corresponding nub on the Ring component, effectively “locking” the Ring to the Spindle. As a result, the lateral movement of the Ring is restricted, disabling the decoupling mechanism between the Arm and the Spindle. In this state, the ADCA functions as a conventional crank arm assembly, providing cyclists with a different riding experience. Importantly, cyclists can choose to disable the decoupling feature on either the left or right side of the ADCA, depending on their preference. Moreover, variations of the Ringlock with shortened or variable-length nubs are possible, offering cyclists the ability to adjust the degree of lateral movement and uncoupled rotation of the Arm according to their specific riding needs. Activation of the Ringlock can be achieved manually, with tools, or through electronic means such as Bluetooth or solenoid-based systems, providing cyclists with convenient control over their riding experience.

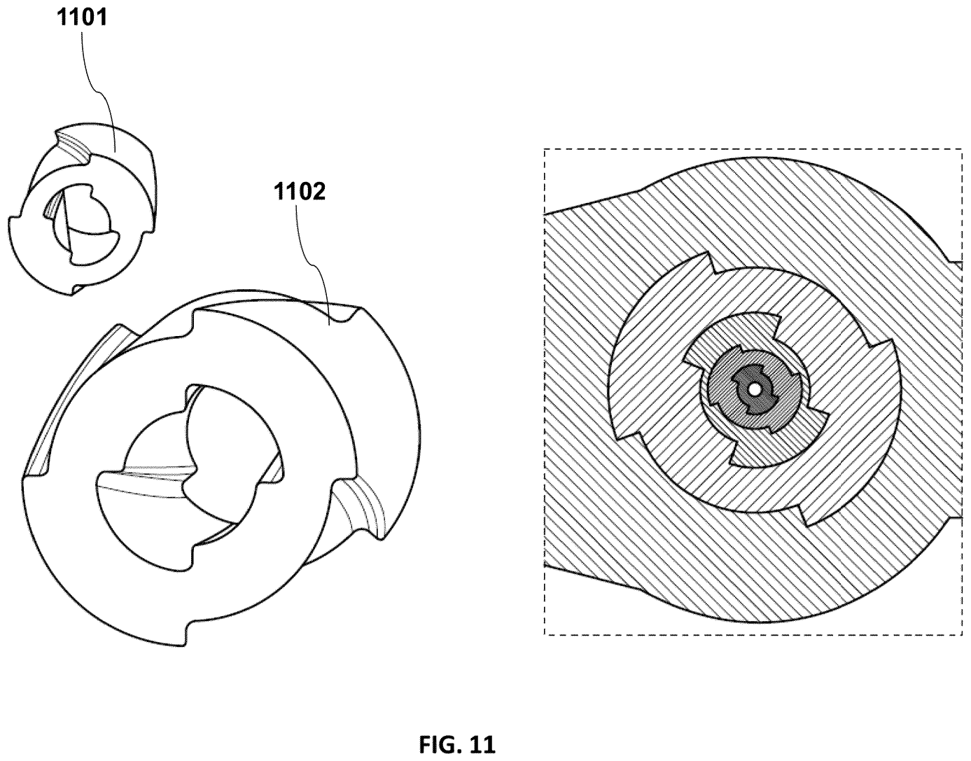

In another embodiment of the Adjustable Decoupling Crank Assembly (ADCA), the design incorporates two additional components, each comprising a tube geometry with helical flutes similar to those found in the other ADCA components but with varying diameters, as illustrated in FIG. 11. These new components, referred to as Tube 1 1101 and Tube 2 1102, are concentrically nested with the existing components in the following order: Spindle, Tube 1 1101, Tube 2 1102, ring, and arm. When assembled, the five components form a cutaway profile as depicted in the figure. During the pedaling motion, Tube 1 1101 and Tube 2 1102 move laterally in opposite directions, contributing to the decoupling mechanism of the ADCA. The inclusion of these additional tubes results in an increased uncoupled rotation potential per lateral movement, effectively doubling the degree of rotation achieved per millimeter of lateral movement (e.g., from 2°/mm to 4°/mm). Furthermore, there is potential to incorporate a third and fourth tube, or even a larger number of tubes, into the concentric nesting arrangement, thereby further amplifying the decoupling effect of the ADCA. This enhanced design offers cyclists an even greater degree of adjustability and customization to enhance their riding experience based on individual preferences and performance requirements.

In a broader context, the concept of utilizing a system composed of concentrically nested helically fluted tubes, with or without the addition of springs as discussed earlier, offers a versatile solution for partially decoupling a rotating component from an axle component. This system can be configured with customizable specifications regarding the range of decoupled rotational movement and the torque required for rotation. Unlike certain conventional gear mechanisms, this system is relatively compact and centered around a single axis, making it suitable for various applications. Beyond cycling technology, such a mechanism holds potential applications in engines or other mechanical devices that involve rotational motion and torque. By allowing the adjustment of the degree of coupling between rotating components, this system offers flexibility in optimizing performance and efficiency across a range of mechanical systems. The ability to fine-tune the decoupling characteristics makes it adaptable to diverse operational requirements and provides opportunities for innovation in engineering design across different industries.

The assembly kit includes two essential tools: a bracenut wrench 1200 and a ringnut wrench, both designed to streamline the assembly process of the crank assembly system. The bracenut wrench 1200 is specifically engineered to securely tighten the bracenut, which plays a pivotal role in holding the arm's brace ring firmly in place. This ensures the stability and proper alignment of the arm relative to the spindle, contributing to the overall structural integrity of the assembly. Conversely, the ringnut wrench is tailored to tighten the ringnut, effectively securing the ring to the arm and completing the assembly of this critical component. These specialized wrenches are instrumental in ensuring the precise and efficient assembly of the crank assembly system, enhancing its overall functionality and performance.

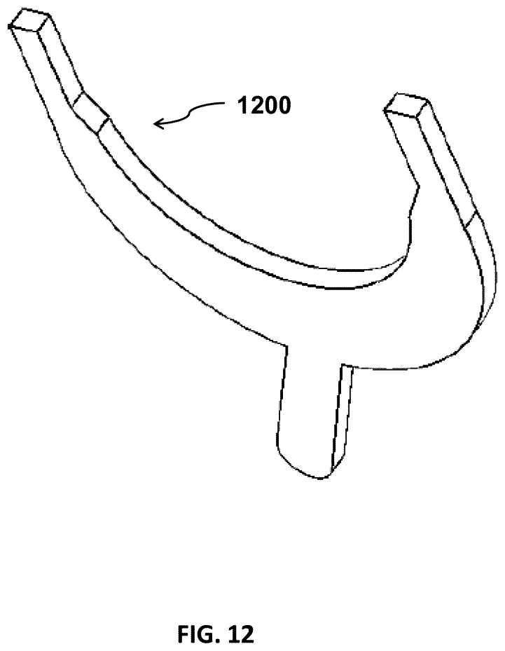

In accordance with an embodiment of the present invention, FIG. 12 illustrates a schematic view of brace nut wrench 1200. As an integral component of the assembly process, the brace nut wrench 1200 is tailored to securely tighten the brace nut, ensuring the proper positioning and stability of the arm's brace ring relative to the spindle. The schematic illustration serves as a visual guide, highlighting the configuration and functionality of the wrench, which plays a crucial role in the efficient and effective assembly of the crank assembly system.

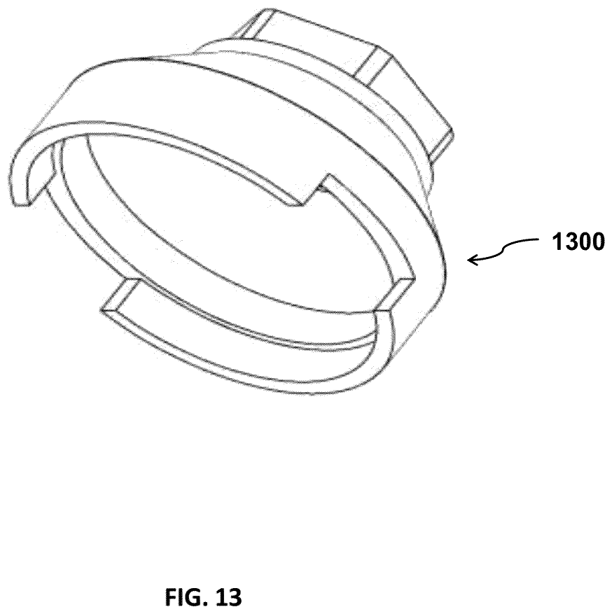

In accordance with an embodiment of the present invention, FIG. 13 illustrates a schematic view of ringnut wrench 1300, a tool designed specifically to facilitate the assembly process of the Adaptive Decoupling Crank Assembly (ADCA). The ringnut wrench 1300 is engineered with features tailored to effectively tighten the ringnut, ensuring a secure and stable connection between the ring and the arm of the crank assembly. Its design allows for efficient and precise manipulation during assembly, contributing to the overall ease and reliability of the installation process. With its specialized functionality, the ringnut wrench plays a crucial role in enabling smooth and seamless assembly of the ADCA components, enhancing the user experience and ensuring optimal performance of the crank assembly system.

The applications of the ADCA assembly extend across various pedal-facilitated machines, encompassing not only traditional bicycles but also exercise bicycles, tricycles, unicycles, hydrobikes, and pedal-based surreys. The versatility of the ADCA makes it suitable for a wide range of human-powered vehicles and exercise equipment, enhancing their performance and efficiency. Whether for recreational cycling, fitness training, or transportation, the ADCA offers a flexible and adaptive solution that can be tailored to different needs and preferences.

Some of the non-limiting advantages of the present invention are:
Improved Pedaling Efficiency: The present invention offers improved pedaling efficiency by redistributing torque requirements throughout the pedal stroke. By introducing partial decoupling of rotational motion between the arm and the spindle, the invention allows cyclists to exert less effort at the top and bottom of the pedal stroke, resulting in smoother transitions and enhanced power transfer.
Enhanced Riding Comfort: With its ability to adjust torque distribution and provide customizable decoupling levels, the invention enhances riding comfort by reducing fatigue and minimizing stress on the cyclist's legs and joints. Cyclists can tailor the decoupling mechanism to suit their individual biomechanics and preferences, resulting in a more comfortable and enjoyable riding experience.
Versatile Adaptability: The invention is designed to be compatible with various bottom bracket configurations and pedal styles, making it versatile and adaptable to different bicycle setups. Whether it's a road bike, mountain bike, or other pedal-driven machine, the invention can seamlessly integrate with existing components, allowing cyclists to upgrade their bikes without compatibility concerns
Increased Performance Potential: By optimizing torque distribution and power transfer, the present invention unlocks the cyclist's full performance potential. Cyclists can achieve higher power outputs and improved speed, especially during challenging riding conditions such as climbing steep hills or sprinting. The invention empowers cyclists to push their limits and achieve peak performance on the bike.
Customizable Riding Experience: With adjustable mechanisms for controlling lateral movement and spring tension, the invention offers a customizable riding experience. Cyclists can fine-tune the decoupling level to match their riding style, terrain, and fitness level, allowing for personalized optimization of pedaling dynamics. This customization capability ensures that cyclists can tailor their riding experience to meet their specific needs and preferences, leading to greater satisfaction and enjoyment on the bike.

Terms and phrases used in this document, and variations thereof, unless otherwise expressly stated, should be construed as open-ended as opposed to limiting. As examples of the foregoing: the term “including” should be read as mean “including, without limitation” or the like; the term “example” is used to provide exemplary instances of the item in the discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A crank assembly system, comprising:
a spindle having a central subsection configured to fit within a hollow bottom bracket;
a ring having a cylindrical tube structure with helical fluting on an inner surface thereof, wherein said ring is configured to screw onto said spindle and said ring having helical fluting on an outer surface thereof,
wherein said ring is configured to receive a compatibly fluted arm;
an arm having a cylindrical tube structure with helical fluting on an inner surface thereof, wherein said arm is configured to receive said ring in a manner allowing rotational motion therebetween;
wherein rotation of said arm causes said ring to screw onto said spindle, and wherein said helical fluting of the spindle, the ring, and the arm enables partial decoupling of rotational motion between the arm and the spindle, such that less torque is required at the beginning and end of a pedal stroke.

2. The crank assembly system of claim 1, further comprising a plurality of compression springs positioned around the ring, wherein the plurality of compression springs counter lateral movement of the ring, providing resistance during pedaling and converting kinetic energy to potential energy during a portion of a pedal stroke and converting potential energy back to kinetic energy in a later portion of the pedal stroke.

3. The crank assembly system of claim 2, wherein the plurality of compression springs are interchangeable, allowing for adjustment of resistance and potential energy conversion based on cyclist preference and terrain.

4. The crank assembly system of claim 1, wherein the spindle is adapted to fit different bottom brackets, including hollow bottom brackets and tapered bottom brackets, by modifying the central subsection.

5. The crank assembly system of claim 1, wherein the ring includes a threaded end configured to connect to a ringnut, thereby maintaining the connection between the ring and the arm.

6. The crank assembly system of claim 1, wherein the arm includes a brace ring that interacts with a brace on the disc for lateral stability and strength of the assembly.

7. The crank assembly system of claim 1, wherein the arm includes threaded holes for attachment of pedals, accommodating different types of pedals including clipped and non-clipped variants.

8. The crank assembly system of claim 1, wherein the helical fluting on the spindle, the ring, and the arm enables a range of decoupling between rotational motion of the arm and the spindle, with configurable specifications in terms of decoupled rotational range and required torque for rotation.

9. The crank assembly system of claim 1, further comprising a mechanism for disabling the decoupling function.

10. The crank assembly system of claim 1, wherein the spindle, ring, and arm are configured in a system of concentrically nested helically fluted tubes/cylinders.

11. The assembly of claim 1, further comprising a bracenut wrench and a ringnut wrench configured to facilitate the assembly of the components, wherein said bracenut wrench is adapted for tightening the bracenut to hold the arm's brace ring in place, and said ringnut wrench is adapted for tightening the ringnut to secure the ring to the arm.

12. A crank assembly system, comprising:
a spindle having a central subsection configured to fit within a hollow bottom bracket;
a tube geometry component concentrically nested with the spindle, the tube geometry component having helical fluting configured to enable decoupling of rotational motion between the tube geometry component and the spindle;
an arm having a cylindrical tube structure with helical fluting on an inner surface thereof, wherein said arm is configured to receive the tube geometry component in a manner allowing rotational motion therebetween;
wherein rotation of the arm causes the tube geometry component to move laterally, enabling partial decoupling of rotational motion between the arm and the spindle, such that less torque is required at the beginning and end of a pedal stroke.

13. The crank assembly system of claim 12, further comprising a locking mechanism for selectively disabling the decoupling function, wherein the locking mechanism allows the cyclist to switch between decoupled and coupled modes during a ride.

14. The crank assembly system of claim 1, wherein the compression springs positioned around the ring are calibrated to provide different levels of resistance based on the cyclist's preference.

15. The crank assembly system of claim 1, wherein the helical fluting on the spindle, the ring, and the arm is configured such that the resistance during the pedal stroke varies in accordance with the cyclist's pedaling motion.
